(19) United States
(12) Patent Application Publication
(10) Pub. No.: US 2026/0274447 A1
(43) Pub. Date: Sep. 17, 2026

(54) System and Method Suitable for Controlling a Spacecraft Orbiting Between a Celestial Body and Moon

(71) Applicant: Mitsubishi Electric Research Laboratories, Inc., Cambridge, MA (US)

(72) Inventors: Avishai Weiss, Boston, MA (US); Yuri Shimane, Atlanta, GA (US); Karl Berntorp, Boston, MA (US); Stefano Di Cairano, Boston, MA (US)

(73) Assignee: Mitsubishi Electric Research Laboratories, Inc., Cambridge, MA (US)

(21) Appl. No.: 19/078,906

(22) Filed: Mar. 13, 2025

(51) Int. Cl. B64G 1/24; B64G 1/36

(52) U.S. Cl. CPC B64G 1/244; B64G 1/242; B64G 1/36

(57) ABSTRACT

The present disclosure provides a system and a method for controlling a spacecraft. The method includes receiving data indicative of measurements of a sequence of positions of the spacecraft and generating, based on the received data, a position measurement of the spacecraft and a covariance of the position measurement. Further, the method includes, based on the position measurement and the covariance of the position measurement, estimating a mean and a covariance of a state of the spacecraft using a probabilistic filter. Furthermore, the method includes determining a mean targeted state of the spacecraft using an unscented transform (UT) on the mean and the covariance of the state of the spacecraft, and determining control commands that steer the spacecraft from the mean targeted state to a reference state of the spacecraft, wherein the reference state includes a crossing point where a desired trajectory of the spacecraft and xz-plane intersect.

### TECHNICAL FIELD

The present disclosure relates generally to control systems, and more specifically to a system and a method suitable for controlling a spacecraft orbiting between a celestial body and moon.

### BACKGROUND

In space exploration, a spacecraft is desired to track a particular trajectory. For instance, in lunar missions, the spacecraft is desired to track a near-rectilinear halo orbit (NRHO) around the moon. Tracking the desired trajectory involves state estimation and motion control of the spacecraft. The state estimation includes estimating a state of the spacecraft and the motion control includes computing control commands for the spacecraft based on the estimated state, to guide the spacecraft along the desired trajectory. The state of the spacecraft includes one or more of a position, a velocity and an orientation of the spacecraft.

The estimation of the state of the spacecraft, however, is challenging due to uncertainty in both measurements used to estimate the state and dynamic lunar environment in which the spacecraft operates. For instance, methods for the estimation of the state of the spacecraft rely on a combination of sensors, such as camera and star trackers, along with on-board computational algorithms to provide estimates of the spacecraft's position and velocity. However, limited accuracy and noise associated with the sensors, compounded by the dynamic lunar environment, introduce uncertainty in the estimation of the state of the spacecraft. Such uncertainty leads to errors in tracking of the desired trajectory, potentially resulting in failure of the lunar mission.

Therefore, there is a need for an improved system and a method for the state estimation and the motion control of the spacecraft to track the desired trajectory.

### SUMMARY

It is an objective of some embodiments to provide a system and a method for accurately estimating a state of the spacecraft and controlling the spacecraft to track a desired trajectory. It is also an objective of some embodiments to control the spacecraft orbiting between a celestial body and moon. The celestial body may be any planet, e.g., Earth. For the purpose of explanation, the celestial body is considered to be the Earth and hereinafter the “celestial body” is referred to as the “Earth”. The spacecraft is desired to orbit the moon along the desired trajectory. The desired trajectory corresponds to any orbit of interest. In an embodiment, the desired trajectory along which the spacecraft orbits corresponds to a near-rectilinear halo orbit (NRHO). The NRHO is a specific type of orbit that a spacecraft can use to orbit Earth-Moon system, particularly in lunar missions. The NRHO is designed to orbit around L2 Lagrange point between the Earth and the moon. The L2 point is one of five points in the Earth-Moon system where gravitational forces and centrifugal force of an orbiting object balance out, allowing the object to remain in a stable position relative to both the Earth and the moon.

It is an objective of some embodiments to control the spacecraft to traverse the desired trajectory. Such a controlling of the spacecraft involves state estimation and motion control. The state estimation includes estimating a state of the spacecraft and the motion control includes computing control commands for the spacecraft based on the estimated state, to guide the spacecraft along the desired trajectory. The state estimation and the motion control are distinct but interconnected because inaccuracies in the state estimation impacts precision and effectiveness of the motion control.

The state estimation relies on measurements, which may be provided from various sources. For example, one approach involves communicating with the Earth, where ground-based measurements are transmitted via radio. Alternatively, in another approach, the spacecraft estimate its position onboard using optical imaging. Both of these approaches, however, suffer from inherent uncertainties. For example, the ground-based measurements face challenges such as interrupted transmissions due to shared resources and increasing density of space objects between the Earth and the Moon. The optical imaging, on the other hand, is prone to inaccuracies in processing images of celestial bodies captured using the optical imaging. These uncertainties complicate the motion control and highlight a need to improve accuracy of the state estimation.

To this end, some embodiments of the present disclosure provide a spacecraft control system that accurately estimates the state of the spacecraft and controls the spacecraft to track the desired trajectory. The spacecraft control system is communicatively coupled to the spacecraft. In some embodiments, the spacecraft control system is integrated into the spacecraft.

The spacecraft control system includes a processor, a memory, a state estimator, and a motion controller. The processor may be a single core processor, a multi-core processor, a computing cluster, or any number of other configurations. The memory may include random access memory (RAM), read only memory (ROM), flash memory, or any other suitable memory systems. Additionally, in some embodiments, the memory may be implemented using a hard drive, an optical drive, a thumb drive, an array of drives, or any combinations thereof. In some embodiments, the state estimator and the motion controller are modules of the spacecraft control system and are executed by the processor. The state estimator is configured to estimate the state of the spacecraft as described below.

To estimate the state of the spacecraft, the state estimator receives data indicative of measurements of a sequence of positions of the spacecraft. In an embodiment, the state estimator receives the data indicative of the measurements of the sequence of positions from the optical imaging. Further, the state estimator generates, based on the received data, a position measurement of the spacecraft and a covariance of the position measurement. The covariance of the position measurement refers to a measure of uncertainty or error associated with the position measurement. The covariance quantifies how much the position measurement is likely to deviate from a true position due to errors or noise in the measurements of the sequence of positions of the spacecraft. In an embodiment, the state estimator generates the position measurement and the covariance of the position measurement by processing the received data with Christian-Robinson algorithm which is a horizon-based, non-iterative method. The Christian-Robinson algorithm is used to generate the position measurement and the covariance of the position measurement due to its superior performance over other iterative, ellipse-fitting-based variants.

Further, based on the position measurement and the covariance of the position measurement, the state estimator estimates a mean and a covariance of the state of the spacecraft using a probabilistic filter. The state of the spacecraft includes a position and a velocity of the spacecraft. The covariance of the state is represented as a covariance matrix (often denoted as P), where each element in the covariance matrix shows a relationship between different components of the state estimate in terms of uncertainty. The probabilistic filter is an unscented Kalman filter or an extended Kalman filter.

The estimated mean and the covariance of the state of the spacecraft are fed to the motion controller. Based on the mean and the covariance of the state of the spacecraft, the motion controller determines the control commands to control a motion of the spacecraft along the desired trajectory. However, some embodiments are based on the recognition that the probabilistic filter alone cannot fully address the inherent uncertainties in the state estimation to a degree sufficient for the motion control. Such a limitation arises from the spacecraft's nonlinear dynamics and a need to predict the state of the spacecraft over extended horizons, often spanning days or even weeks.

To address these challenges, some embodiments use the covariance matrix, to improve the motion control. In spacecraft applications, after the mean of the state is estimated, the covariance matrix is ignored in the motion control. For instance, the motion controller employs an xz-plane crossing control. The xz-plane crossing control involves targeting a future state by simply propagating the mean of the state of the spacecraft. Some embodiments are based on the realization that since for control, the state propagation is over a significantly long time (across multiple revolutions along the orbit), it is advantageous to leverage the covariance matrix in the propagation of the mean of the state of the spacecraft to better capture effects of the nonlinear dynamics and enhance precision of the motion control. Specifically, unscented transform (UT) can be employed to propagate state estimates using their associated covariance, improving accuracy of the control commands by better accounting for the spacecraft's nonlinear dynamics.

The UT is a technique that approximates how a probability distribution evolves through a nonlinear function. The UT generates representative points, called sigma points, based on the mean and the covariance of the state. These sigma points are propagated through the nonlinear function, capturing how the nonlinear dynamics transform the mean and the covariance of the state. The sigma points are then used to compute an updated mean and covariance of the state of the spacecraft, directly accounting for effects of the nonlinear dynamics.

Further, some embodiments are based on the recognition that periodic orbits about equilibrium points along Earth-Moon line, denoted as x-axis, exhibit a symmetry about xz-plane, defined by the x-axis and a z-axis aligned with angular momentum of the Moon about the Earth. Periodic nature of the desired trajectory enables use of the xz-plane crossing control to transform the motion control from tracking a continuous trajectory to tracking the spacecraft's state at specific crossing points. The crossing points are locations where the desired trajectory intersects the xz-plane. Due to the periodicity of the desired trajectory, the crossing points can correspond to the same spatial locations traversed by the spacecraft at different times. The xz-plane crossing control is a method used in the motion control that focuses on guiding the spacecraft to the crossing points where its trajectory intersects the xz-plane. By targeting the crossing points rather than the entire desired trajectory, the spacecraft control system simplifies the motion control while preserving the spacecraft in vicinity of the desired trajectory.

In such a manner, the state estimator and the motion controller work in tandem to control the motion of the spacecraft to track the desired trajectory. Some embodiments are based on the realization that combining the UT to determine the mean targeted state with the xz-plane crossing control offers an effective solution. By targeting UT-based predicted state (i.e., the mean targeted state), the control commands can be optimized over long prediction horizons even when spanning days or weeks. Thereby, the spacecraft control system is usable for long-duration missions, while maintaining only marginally increasing computational cost, making it feasible for implementation on processors, including embedded processors typically used onboard spacecraft.

Further, focusing on the crossing points, the spacecraft control system reduces computational demands and leverages the periodicity of the desired trajectory for more efficient state optimization. This method not only conserves computational resources but also improves predictability, making it a practical solution for real-time implementation on resource-constrained processors onboard spacecraft. The simplicity and reliability of the xz-plane crossing control make it particularly effective for managing complex nonlinear dynamics and long-duration missions.

Accordingly, one embodiment discloses a spacecraft control system comprising a state estimator and a motion controller employing XZ-plane crossing control. The state estimator is configured to: receive data indicative of measurements of a sequence of positions of the spacecraft; generate, based on the received data, a position measurement of the spacecraft and a covariance of the position measurement; and based on the position measurement and the covariance of the position measurement, estimate a mean and a covariance of a state of the spacecraft using a probabilistic filter, wherein the state of the spacecraft includes a position and a velocity of the spacecraft. The motion controller employing the XZ-plane crossing control is configured to: determine a mean targeted state of the spacecraft using an unscented transform (UT) on the mean and the covariance of the state of the spacecraft; determine control commands that steer the spacecraft from the mean targeted state to a reference state of the spacecraft, wherein the reference state includes a crossing point where a desired trajectory of the spacecraft and xz-plane intersect; and control one or more actuators of the spacecraft based on the control commands to track the desired trajectory.

Accordingly, one embodiment discloses a spacecraft control method, comprising: receiving data indicative of measurements of a sequence of positions of the spacecraft; generating, based on the received data, a position measurement of the spacecraft and a covariance of the position measurement; based on the position measurement and the covariance of the position measurement, estimating a mean and a covariance of a state of the spacecraft using a probabilistic filter, wherein the state of the spacecraft includes a position and a velocity of the spacecraft; determining a mean targeted state of the spacecraft using an unscented transform (UT) on the mean and the covariance of the state of the spacecraft; determining control commands that steer the spacecraft from the mean targeted state to a reference state of the spacecraft, wherein the reference state includes a crossing point where a desired trajectory of the spacecraft and xz-plane intersect; and controlling one or more actuators of the spacecraft based on the control commands to track the desired trajectory.

Accordingly, yet another embodiment discloses a non-transitory computer-readable storage medium embodied thereon a program executable by a processor for performing a spacecraft control method. The spacecraft control method comprises receiving data indicative of measurements of a sequence of positions of the spacecraft; generating, based on the received data, a position measurement of the spacecraft and a covariance of the position measurement; based on the position measurement and the covariance of the position measurement, estimating a mean and a covariance of a state of the spacecraft using a probabilistic filter, wherein the state of the spacecraft includes a position and a velocity of the spacecraft; determining a mean targeted state of the spacecraft using an unscented transform (UT) on the mean and the covariance of the state of the spacecraft; determining control commands that steer the spacecraft from the mean targeted state to a reference state of the spacecraft, wherein the reference state includes a crossing point where a desired trajectory of the spacecraft and xz-plane intersect; and controlling one or more actuators of the spacecraft based on the control commands to track the desired trajectory.

### BRIEF DESCRIPTION OF THE DRAWINGS

The presently disclosed embodiments will be further explained with reference to the attached drawings. The drawings shown are not necessarily to scale, with emphasis instead generally being placed upon illustrating the principles of the presently disclosed embodiments.

FIG. 1A illustrates a spacecraft orbiting between a celestial body and moon, according to some embodiments of the present disclosure.

FIG. 1B illustrates a block diagram of a spacecraft control system, according to some embodiments of the present disclosure.

FIG. 1C illustrates a block diagram for estimating a state of the spacecraft by a state estimator, according to some embodiments of the present disclosure.

FIG. 1D illustrates a block diagram for controlling a motion of the spacecraft by a motion controller, according to some embodiments of the present disclosure.

FIG. 1E illustrates controlling thrusters of the spacecraft based on control commands, according to some embodiments of the present disclosure.

FIG. 2A illustrates receiving of measurements of a sequence of positions of the spacecraft, according to some embodiments of the present disclosure.

FIG. 2B illustrates receiving of the measurements of the sequence of positions of the spacecraft using optical imaging, according to some embodiments of the present disclosure.

FIG. 3 illustrates a covariance of a position measurement, according to some embodiments of the present disclosure.

FIG. 4A illustrates different points on a desired trajectory for capturing optical images of the moon, according to some embodiments of the present disclosure.

FIG. 4B illustrates an example optimal control point, according to some embodiments of the present disclosure.

FIG. 5A illustrates pre-specified locations on the desired trajectory at which multiple control maneuvers are planned, according to some embodiments of the present disclosure.

FIG. 5B illustrates a near-rectilinear halo orbit (NRHO) shown with instantaneous true anomaly for a duration of 10 revolutions, seen from near-side of the Moon (Earth-side observer) in a Earth-Moon rotating frame, according to some embodiments of the present disclosure.

FIG. 6 is a schematic illustrating by non-limiting example a computing apparatus for implementing the methods and the systems of the present disclosure.

FIG. 7 is a schematic diagram illustrating some components used for implementing methods and systems of the present disclosure.

### DETAILED DESCRIPTION

In the following description, for purposes of explanation, numerous specific details are set forth in order to provide a thorough understanding of the present disclosure. It will be apparent, however, to one skilled in the art that the present disclosure may be practiced without these specific details. In other instances, apparatuses and methods are shown in block diagram form only in order to avoid obscuring the present disclosure.

As used in this specification and claims, the terms “for example,” “for instance,” and “such as,” and the verbs “comprising,” “having,” “including,” and their other verb forms, when used in conjunction with a listing of one or more components or other items, are each to be construed as open ended, meaning that that the listing is not to be considered as excluding other, additional components or items. The term “based on” means at least partially based on. Further, it is to be understood that the phraseology and terminology employed herein are for the purpose of the description and should not be regarded as limiting. Any heading utilized within this description is for convenience only and has no legal or limiting effect.

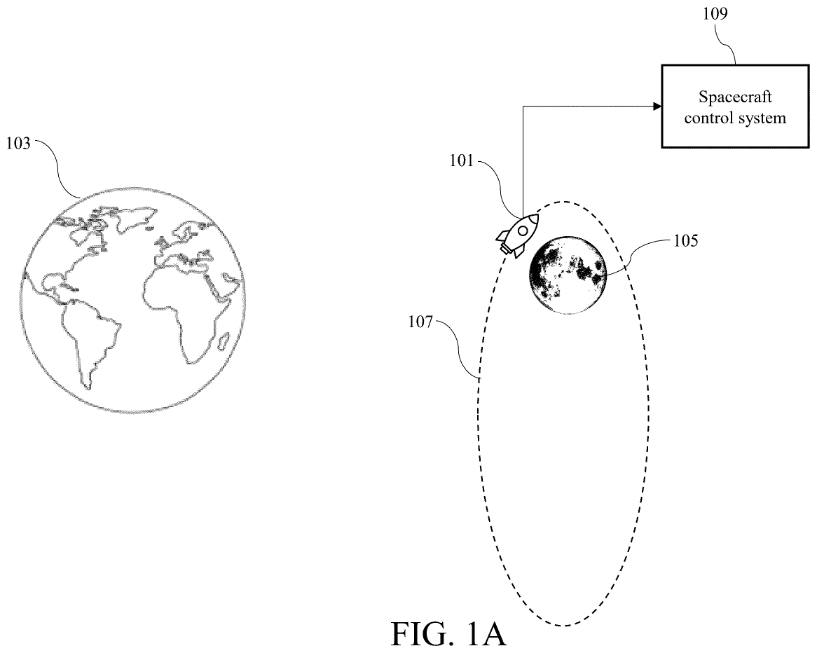

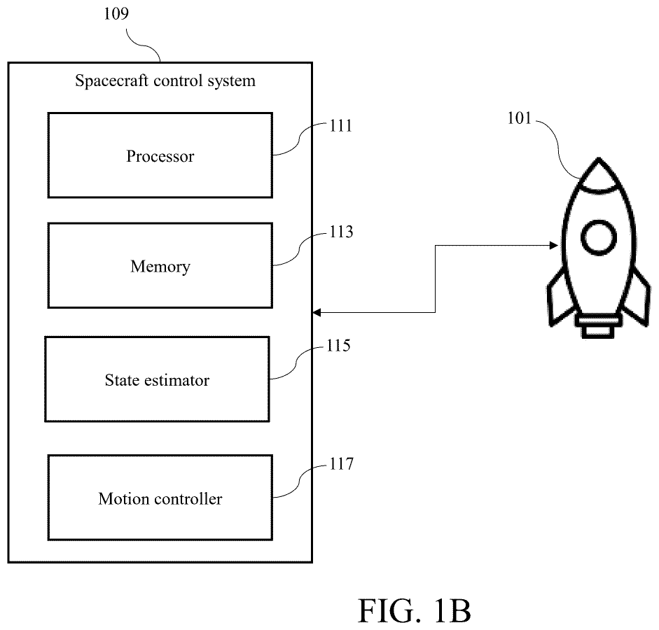

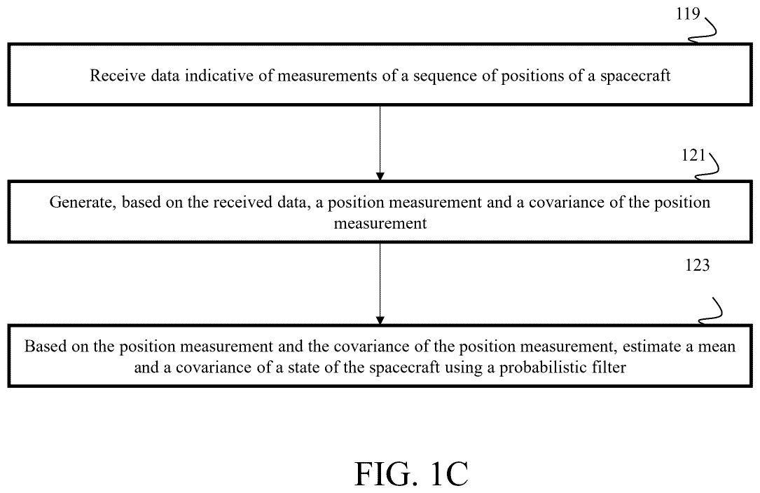

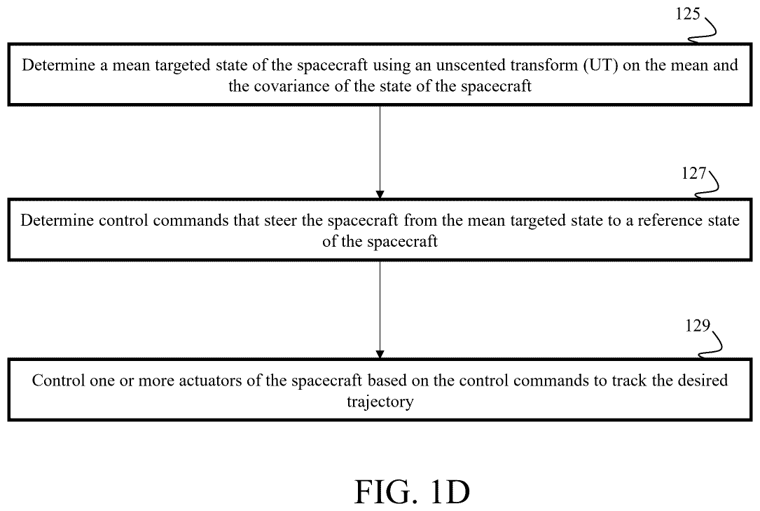

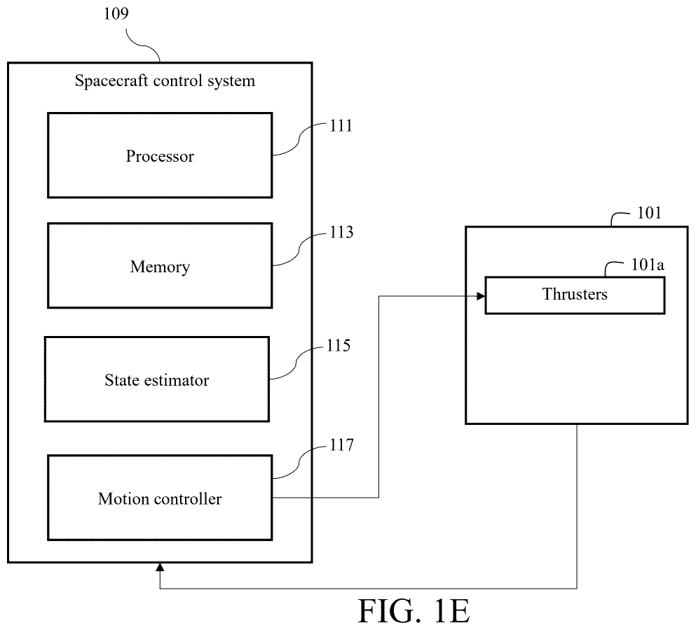

FIG. 1A illustrates a spacecraft 101 orbiting between a celestial body 103 and moon 105, according to some embodiments of the present disclosure. The celestial body 103 may be any planet, e.g., Earth. For the purpose of explanation, the celestial body 103 is considered to be the Earth and hereinafter the “celestial body 103” is referred to as the “Earth 103”.

The spacecraft 101 is desired to orbit the moon 105 along a desired trajectory 107. The desired trajectory 107 corresponds to any orbit of interest. In an embodiment, the desired trajectory 107 along which the spacecraft 101 orbits corresponds to a near-rectilinear halo orbit (NRHO). The NRHO is a specific type of orbit that a spacecraft can use to orbit Earth-Moon system, particularly in lunar missions. The NRHO is designed to orbit around L2 Lagrange point between the Earth 103 and the moon 105. The L2 point is one of five points in the Earth-Moon system where gravitational forces and centrifugal force of an orbiting object balance out, allowing the object to remain in a stable position relative to both the Earth 103 and the moon 105.

It is an objective of some embodiments to control the spacecraft 101 to traverse the desired trajectory 107. Such a controlling of the spacecraft 101 involves state estimation and motion control. The state estimation includes estimating a state of the spacecraft 101 and the motion control includes computing control commands for the spacecraft 101 based on the estimated state, to guide the spacecraft 101 along the desired trajectory 107. The state estimation and the motion control are distinct but interconnected because inaccuracies in the state estimation impacts precision and effectiveness of the motion control.

The state estimation relies on measurements, which may be provided from various sources. For example, one approach involves communicating with the Earth 103, where ground-based measurements are transmitted via radio. Alternatively, in another approach, the spacecraft 107 estimate its position onboard using optical imaging. Both of these approaches, however, suffer from inherent uncertainties. For example, the ground-based measurements face challenges such as interrupted transmissions due to shared resources and increasing density of space objects between the Earth 103 and the Moon 105. The optical imaging, on the other hand, is prone to inaccuracies in processing images of celestial bodies captured using the optical imaging. These uncertainties complicate the motion control and highlight a need to improve accuracy of the state estimation.

To this end, some embodiments of the present disclosure provide a spacecraft control system 109 that accurately estimates the state of the spacecraft 101 and controls the spacecraft 101 to track the desired trajectory 107.

FIG. 1B illustrates a block diagram of the spacecraft control system 109, according to some embodiments of the present disclosure. The spacecraft control system 109 is communicatively coupled to the spacecraft 101. In some embodiments, the spacecraft control system 109 is integrated into the spacecraft 101.

The space craft control system 109 includes a processor 111, a memory 113, a state estimator 115, and a motion controller 117. The processor 111 may be a single core processor, a multi-core processor, a computing cluster, or any number of other configurations. The memory 113 may include random access memory (RAM), read only memory (ROM), flash memory, or any other suitable memory systems. Additionally, in some embodiments, the memory 113 may be implemented using a hard drive, an optical drive, a thumb drive, an array of drives, or any combinations thereof. In some embodiments, the state estimator 115 and the motion controller 117 are modules of the spacecraft control system 109 and are executed by the processor 111. The state estimator 115 is configured to estimate the state of the spacecraft 101 as described below in FIG. 1C.

FIG. 1C illustrates a block diagram for estimating the state of the spacecraft 101 by the state estimator 115, according to some embodiments of the present disclosure. At block 119, the state estimator 115 receives data indicative of measurements of a sequence of positions of the spacecraft 101. In an embodiment, the state estimator 115 receives the data indicative of the measurements of the sequence of positions from the optical imaging.

At block 121, the state estimator 115 generates, based on the received data, a position measurement of the spacecraft 101 and a covariance of the position measurement. The covariance of the position measurement refers to a measure of uncertainty or error associated with the position measurement. The covariance quantifies how much the position measurement is likely to deviate from a true position due to errors or noise in the measurements of the sequence of positions of the spacecraft 101. In an embodiment, the state estimator 115 generates the position measurement and the covariance of the position measurement by processing the received data with Christian-Robinson algorithm which is a horizon-based, non-iterative method. The Christian-Robinson algorithm is used to generate the position measurement and the covariance of the position measurement due to its superior performance over other iterative, ellipse-fitting-based variants.

At block 123, based on the position measurement and the covariance of the position measurement, the state estimator 115 estimates a mean and a covariance of the state of the spacecraft 101 using a probabilistic filter. The state of the spacecraft 101 includes a position and a velocity of the spacecraft 101. The covariance of the state is represented as a covariance matrix (often denoted as P), where each element in the covariance matrix shows a relationship between different components of the state estimate in terms of uncertainty. The probabilistic filter is an unscented Kalman filter or an extended Kalman filter.

The estimated mean and the covariance of the state of the spacecraft 101 are fed to the motion controller 117. Based on the mean and the covariance of the state of the spacecraft 101, the motion controller 117 determines the control commands to control a motion of the spacecraft 101 along the desired trajectory 107.

FIG. 1D illustrates a block diagram for controlling the motion of the spacecraft 101 by the motion controller 117, according to some embodiments of the present disclosure. Some embodiments are based on the recognition that the probabilistic filter alone cannot fully address the inherent uncertainties in the state estimation to a degree sufficient for the motion control. Such a limitation arises from the spacecraft's nonlinear dynamics and a need to predict the state of the spacecraft 101 over extended horizons, often spanning days or even weeks.

To address these challenges, some embodiments use the covariance matrix, to improve the motion control. In spacecraft applications, after the mean of the state is estimated, the covariance matrix is ignored in the motion control. For instance, the motion controller 117 employs an xz-plane crossing control. The xz-plane crossing control involves targeting a future state by simply propagating the mean of the state of the spacecraft 101. Some embodiments are based on the realization that since for control, the state propagation is over a significantly long time (across multiple revolutions along the orbit), it is advantageous to leverage the covariance matrix in the propagation of the mean of the state of the spacecraft 101 to better capture effects of the nonlinear dynamics and enhance precision of the motion control. Specifically, unscented transform (UT) can be employed to propagate state estimates using their associated covariance, improving accuracy of the control commands by better accounting for the spacecraft's nonlinear dynamics.

The UT is a technique that approximates how a probability distribution evolves through a nonlinear function. The UT generates representative points, called sigma points, based on the mean and the covariance of the state. These sigma points are propagated through the nonlinear function, capturing how the nonlinear dynamics transform the mean and the covariance of the state. The sigma points are then used to compute an updated mean and covariance of the state of the spacecraft 101, directly accounting for effects of the nonlinear dynamics.

Further, some embodiments are based on the recognition that periodic orbits about equilibrium points along Earth-Moon line, denoted as x-axis, exhibit a symmetry about xz-plane, defined by the x-axis and a z-axis aligned with angular momentum of the Moon 105 about the Earth 103. Periodic nature of the desired trajectory 107 enables use of the xz-plane crossing control to transform the motion control from tracking a continuous trajectory to tracking the spacecraft's state at specific crossing points. The crossing points are locations where the desired trajectory 107 intersects the xz-plane. Due to the periodicity of the desired trajectory 107, the crossing points can correspond to the same spatial locations traversed by the spacecraft 101 at different times. The xz-plane crossing control is a method used in the motion control that focuses on guiding the spacecraft 101 to the crossing points where its trajectory intersects the xz-plane. By targeting the crossing points rather than the entire desired trajectory 107, the spacecraft control system 109 simplifies the motion control while preserving the spacecraft 101 in vicinity of the desired trajectory 107.

To this end, at block 125, the motion controller 117 determines a mean targeted state of the spacecraft using the UT on the mean and the covariance of the state of the spacecraft 101.

At block 127, the motion controller 117 determines control commands that steer the spacecraft 101 from the mean targeted state to a reference state of the spacecraft 101. The reference state includes the crossing point where the desired trajectory 107 of the spacecraft 101 and the xz-plane intersect. In an embodiment, the motion controller 117 solves a nonlinear program to determine the control commands such that a difference between the mean targeted state and the reference state satisfies a tolerance.

At block 129, the motion controller 117 controls one or more actuators of the spacecraft 101 based on the control commands to track the desired trajectory 107. For instance, the one or more actuators correspond to thrusters 101 of the spacecraft 101 as shown in FIG. 1E. The thrusters 101a are configured to produce forces that maintain the spacecraft 101 along the desired trajectory 107. For instance, in an embodiment, the spacecraft 101 may be equipped with eight thrusters that are mounted at corners of the spacecraft101 so that they align and produce forces that act on a center of mass of the spacecraft 101 without producing any torques that would rotate the vehicle.

The motion controller 117 is configured to apply the control commands to the thrusters 101. The thrusters 101a produce forces according to the control commands. The produced forces steer the spacecraft 101 towards the reference state to track the desired trajectory 107.

In such a manner, the state estimator 115 and the motion controller 117 work in tandem to control the motion of the spacecraft 101 to track the desired trajectory 107. Some embodiments are based on the realization that combining the UT to determine the mean targeted state with the xz-plane crossing control offers an effective solution. By targeting UT-based predicted state (i.e., the mean targeted state), the control commands can be optimized over long prediction horizons even when spanning days or weeks. Thereby, the spacecraft control system 109 is usable for long-duration missions, while maintaining only marginally increasing computational cost, making it feasible for implementation on processors, including embedded processors typically used onboard spacecraft.

Further, focusing on the crossing points, the spacecraft control system 109 reduces computational demands and leverages the periodicity of the desired trajectory 107 for more efficient state optimization. This method not only conserves computational resources but also improves predictability, making it a practical solution for real-time implementation on resource-constrained processors onboard spacecraft. The simplicity and reliability of the xz-plane crossing control make it particularly effective for managing complex nonlinear dynamics and long-duration missions.

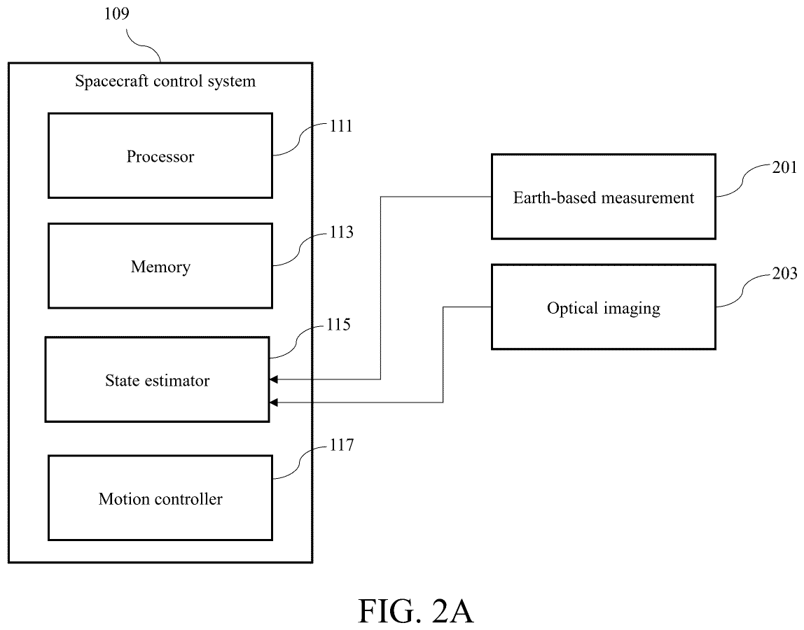

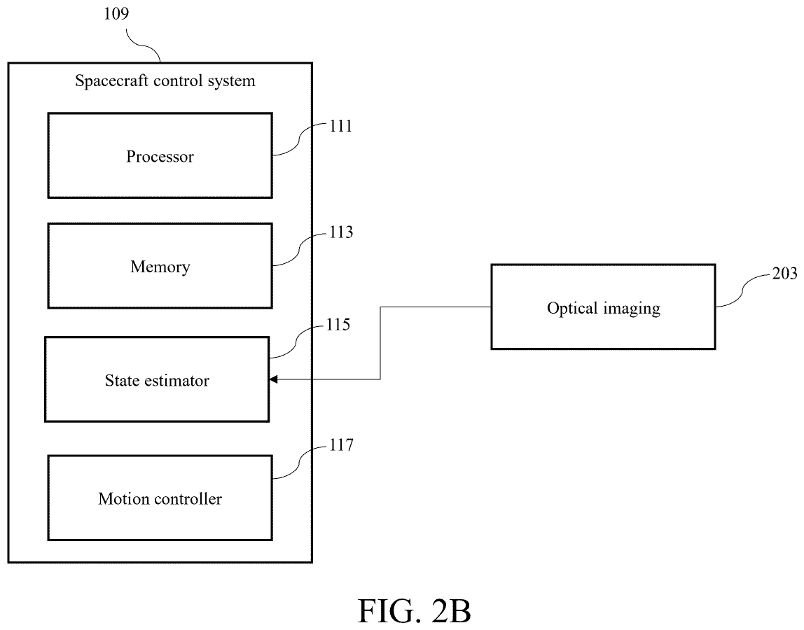

Some embodiments are based on the recognition that the state estimator 115 can receive the measurements of the sequence of positions of the spacecraft 101 from Earth-based transmissions and the optical imaging. FIG. 2A illustrates receiving of the measurements of the sequence of positions of the spacecraft 101, according to some embodiments of the present disclosure. The state estimator 115 receives the measurements of the sequence of positions from Earth-based transmission 201. The Earth-based transmission 201 involves communicating with a ground-based station from which ground-based measurements including the measurements of the sequence of positions of the spacecraft 101 are transmitted to the spacecraft control system 101 via radio. Further, the state estimator 115 receives the measurements of the sequence of positions using optical imaging 203. The optical imaging 203 refers to use of imaging systems (such as cameras, lidar, or other sensors) of the spacecraft 101 that are configured to capture optical images of the moon 105 to generate the measurements of the sequence of positions of the spacecraft 101 relative to the moon 105.

In some embodiments, the state estimator 115 receives the measurements of the sequence of positions of the spacecraft 101 only from the Earth-based transmission 201. Some embodiments are based on the realization that receiving the measurements of the sequence of positions of the spacecraft 101 only using the optical imaging 203 is advantageous as it eliminates reliance on external sources and the optical images are directly captured by the spacecraft's onboard equipment. To this end, in some embodiments, the state estimator 115 receives the measurements of the sequence of positions of the spacecraft 101 only using the optical imaging 203, as shown in FIG. 2B. The optical images are processed with the Christian-Robinson algorithm to generate the position measurement of the spacecraft 101 and the covariance of the position measurement.

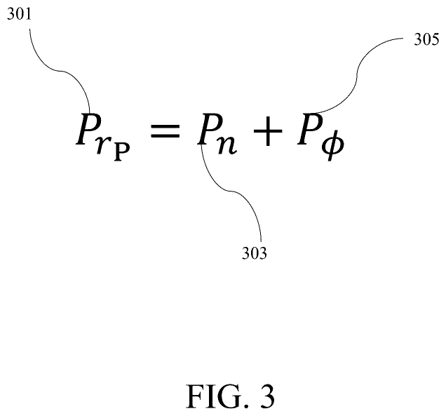

FIG. 3 illustrates the covariance of the position measurement, according to some embodiments of the present disclosure. In some embodiments, the state estimator 115 generates the covariance of the position measurement with an assumption that an attitude, i.e., orientation, of the spacecraft 101 is known accurately. However, the attitude of the spacecraft 101 may not be known with complete accuracy due to uncertainties and errors in attitude sensors such as star trackers, hardware imperfections, and other factors. Since the optical imaging 203 relies on precise attitude information to produce inertial position measurements, accurate attitude information is critical for generating reliable position measurements. Some embodiments are based on the realization that, because the covariance matrix is utilized in subsequent motion control, the covariance of the position measurement must account for uncertainties and errors associated with the attitude of the spacecraft 101. Therefore, the covariance of the position measurement is augmented with a term that captures sensitivity of the position measurement to the uncertainties and the errors associated with the attitude of the spacecraft 101. Such an augmentation ensures that the uncertainties and the errors associated with the attitude of the spacecraft 101 are effectively reflected in the covariance matrix, improving the overall performance of the probabilistic filter, which in turn improves the robustness performance and robustness of the motion control.

To this end, a covariance 301 of the position measurement, Pᵣₚ, includes a position measure covariance 303, Pₙ, and an attitude covariance 305, P_{φ}. The position measure covariance 303, Pₙ, quantifies how much the position measurement is likely to deviate from the true position due to the errors or the noise in the measurements of the sequence of positions of the spacecraft 101. The attitude covariance 305, P_{φ}, captures sensitivity of the position measurement with respect to the uncertainties and the errors associated with the attitude of the spacecraft 101.

The optical images are captured by the imaging system of the spacecraft 101 at different locations on the desired trajectory 107. These different locations on the desired trajectory 107 are selected based on at least one of a range from the moon 105, illumination conditions, and operational constraints of the spacecraft 101.

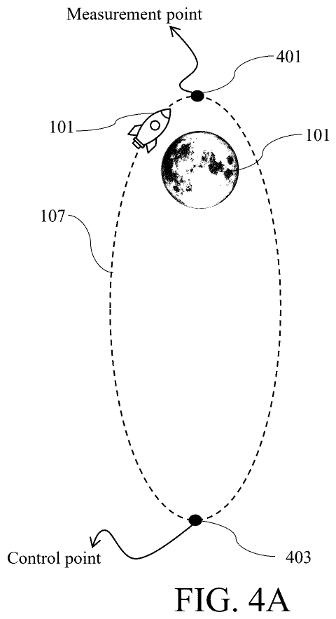

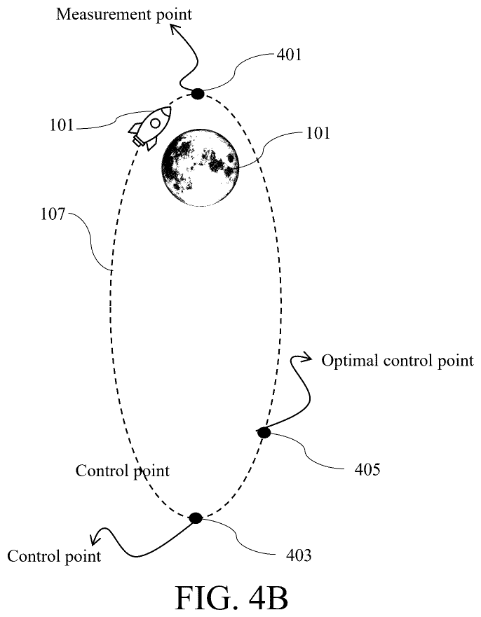

FIG. 4A illustrates different points on the desired trajectory 107 for capturing the optical images of the moon 105, according to some embodiments of the present disclosure. The desired trajectory 107 includes a perilune point 401 and an apolune point 403. The perilune point 401 is a point in a spacecraft's orbit (i.e., desired trajectory 107) around the moon 105 that is closest to moon's surface. The apolune point 403 is a point in the spacecraft's orbit around the moon 105 that is farthest from the moon's surface. At the apolune point 403, the spacecraft is at its maximum distance from the moon 105

At the perilune point 401, the spacecraft 101 is at its minimum distance from the moon 105 and has greater observability. Additionally, at the perilune point 401, the moon 105 fits within a field of view of the imaging system of the spacecraft 101. Therefore, the optical images are captured at the perilune point 401 to obtain better optical images, which when further used for the state estimation yields accurate estimate of the state of the spacecraft 101.

Some embodiments are based on the recognition that while capturing the optical images and performing the state estimation at the perilune point 401 is advantageous, executing the control commands at the perilune point 401 is not effective as dynamics of the spacecraft 101 is faster and unstable at or near the perilune point 401, leading to deviations downstream. Due to dynamical stability considerations, the control is applied (i.e., the control commands are executed) at the apolune point 403, the farthest position of the spacecraft's orbit about the moon. However, the point at which state estimation error is least does not coincide with the apolune point 403. The state estimation error is a difference between the state of the spacecraft 101 estimated by the probabilistic filter and an actual state of the spacecraft 101.

Therefore, some embodiments aim to determine an optimal control point that balances dynamic stability of the spacecraft 101 and the state estimation error. In one embodiment, the optimal control location is determined by running simulations that trade-off dynamic stability considerations with the state estimation error. The optimal control point is determined in advance, i.e., offline and stored in the memory 113 of the spacecraft control system 109. The motion controller 117 executes the control commands at this optimal control point.

Further, the optimal control point is a point at which a cumulative propellant cost of the motion control is minimum. The cumulative propellant cost of the motion control refers to a total amount of propellant required for the spacecraft 101 to perform its required maneuvers. Minimizing the cumulative propellant cost results in minimum usage of the propellant, leading to a fuel-efficient operation of the spacecraft 101. Therefore, executing the control commands at this optimal control point results in the fuel-efficient operation of the spacecraft 101.

FIG. 4B illustrates an example optimal control point 405, according to some embodiments of the present disclosure. The optimal control point 405 lies between the perilune point 401 and the apolune point 403 on the desired trajectory 107. For instance, in some embodiments, the optimal control point 405 lies near to the apolune point 403.

Additionally, some embodiments are based on the realization that improved motion control performance, such as reduced fuel consumption and tracking the desired trajectory 107 under greater uncertainty, can be achieved by steering the covariance of the state rather than the mean of the state of the spacecraft 101 alone. To steer the covariance of the state, the motion controller 107 may be modified to simultaneously plan multiple control maneuvers at pre-specified locations on the desired trajectory, thereby augmenting the degree of freedom for control. In an embodiment, planning the multiple control maneuvers at the pre-specified locations refers to executing the multiple control maneuvers at the pre-specified locations. By steering the covariance of the state, these multiple control maneuvers optimize control efficiency.

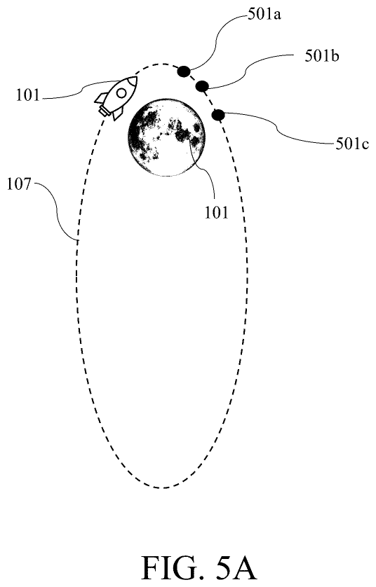

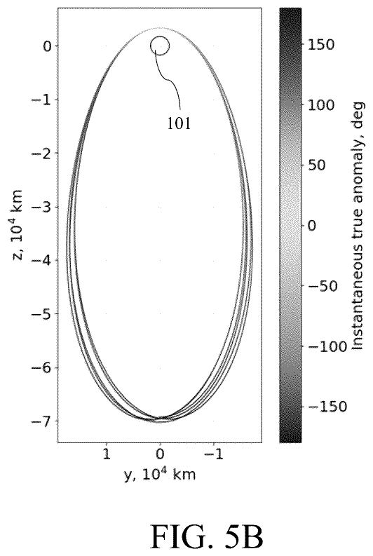

FIG. 5A illustrates the pre-specified locations on the desired trajectory 107 at which the multiple control maneuvers are planned, according to some embodiments of the present disclosure. For example, points 501a, 501b, and 501c are the pre-specified locations at which the multiple control maneuvers are planned.

Since the covariance of the state of the spacecraft 101 is influenced by the points at which the optical images are captured, the multiple control maneuvers can be strategically planned at points on the desired trajectory 107 where the covariance of the state has been shaped to be minimal. To this end, in an embodiment, the points 501a, 501b, and 501c correspond to the points where the covariance of the state has been shaped to be minimal and the multiple control maneuvers are planned at the points 501a, 501b, and 501c. Such an integration of optimized measurement and control strategies enhances the robustness and efficiency of spacecraft operations in complex dynamical environments, such as NRHO.

The state estimation, the motion control, and the probabilistic filter used by the spacecraft control system 109 are mathematically explained below.

The present disclosure considers the motion of the spacecraft 101 in cislunar space under effect of gravitational forces of the Moon, Earth and Sun, along with J2 perturbation from the Moon and solar radiation pressure (SRP), in a Moon-centered inertial frame F_{I}. Equations of the motion of the spacecraft 101 are given by

$$\dot{θ} = [ \begin{matrix}\dot{r} \\ \dot{v}\end{matrix} ] = f ( t , θ ) = [ \begin{matrix}v \\ - \frac{μ}{{r}^{3}} r + {a}_{J 2} ( r ) + {\sum }_{i} {a}_{{N}_{i}} ( t , r ) + {a}_{SRP} ( t , r )\end{matrix} ] , \qquad ( 1 )$$

where r∈ [symbol] ³ is a position vector of the spacecraft with respect to an unforced particle at an origin of F_{I}, v≙\dot{r}∈ [symbol] ³ is a rate of change of r in F_{I}, and θ^{T}=[r^{T}, v^{T}]∈ [symbol] ⁶ is a state vector. In acceleration terms on the right-hand side, r=∥r∥ is a distance from a center of the Moon to the spacecraft, μ is a standard gravitational parameter of the Moon, a_{J2} is a perturbing acceleration due to J2 coefficient of a lunar spherical harmonic gravitational model, a_{N}_{ᵢ} is a third-body perturbing acceleration of body i, and a_{SRP} is a perturbing acceleration due to SRP. The perturbation terms are given by

$${a}_{J 2} ( r ) = {T}_{I}^{P} ( - \frac{3 μ {J}_{2} {R}^{2}}{2 {r}^{5}} [ \begin{matrix}( 1 - \frac{5 {z}_{p}^{2}}{{r}^{2}} ) {x}_{P} \\ ( 1 - \frac{5 {z}_{p}^{2}}{{r}^{2}} ) {y}_{P} \\ ( 3 - \frac{5 {z}_{p}^{2}}{{r}^{2}} ) {z}_{P}\end{matrix} ] ) \\ {a}_{{N}_{i}} ( t , r ) = - {μ}_{i} ( \frac{r - {d}_{i}}{{‖ r - {d}_{i} ‖}^{3}} + \frac{{d}_{i}}{{d}_{i}^{3}} ) \\ {a}_{SRP} ( t , r ) = {{P}_{Sun} ( \frac{{‖ {d}_{Earth} - {d}_{Sun} ‖}_{2}}{{r}_{Sun}} )}^{2} {C}_{r} \frac{A}{m} \frac{{r}_{Sun}}{{r}_{Sun}}$$

Linearized solution to equation (1) in vicinity of a reference state θ̅ at time t is given by

$$δ θ ( t ) = \frac{\partial θ ( t )}{\partial \overline{θ} ( {t}_{0} )} δ θ ( {t}_{0} ) \qquad ( 2 )$$

where δθ (t₀) denotes an initial deviation from an initial reference state θ̅ (t₀) at time t₀. Partial ∂θ(t)/∂θ̅(t₀) is a state-transition matrix (STM) denoted by a shorthand Φ(t, t₀), obtained through a nonlinear integration of an initial value problem

$$\{ \begin{matrix}\dot{Φ} ( t , {t}_{0} ) = \frac{\partial f ( t , θ )}{\partial \overline{θ}} \vert Φ ( t , {t}_{0} ) , \\ Φ ( {t}_{0} , {t}_{0} ) = {I}_{6} .\end{matrix} \qquad ( 3 )$$

### System Architecture for the State Estimation and Motion Control

To validate an ability for the state estimation and motion control on the NRHO, a simulation environment is built. The simulation environment generates synthetic images of the Moon, processes the images to generate position measurements and position measurement covariances, estimates the spacecraft state using a navigation filter (i.e., a probabilistic filter), and computes orbital correction maneuvers using a SK controller (e.g., the xz-plane crossing control). The state estimation is explained in detail below

### State Estimation

### Horizon-Based Optical Navigation

The horizon-based optical navigation (OPNAV) algorithm is considered for computing the position vector of the spacecraft with respect to the imaged body when the attitude of the spacecraft is given to the horizon-based OPNAV algorithm. This assumption is built on a fact that spacecraft attitude information may be acquired to a high precision using the star trackers. The (albeit small) error on the spacecraft's attitude is incorporated into the image generation process, and the measurement covariance expression is updated to reflect the error on the spacecraft's attitude. The horizon-based OPNAV algorithm also requires information on ephemerides of the celestial bodies as well as a physical property of the imaged body, which are assumed to be known as they can be pre-loaded and made available to the spacecraft control system 109.

### A.1. Christian-Robinson Algorithm

The Christian-Robinson algorithm provides both the position vector estimate as well as an analytical expression for the position measurement covariance. Starting from m pixel coordinates corresponding to lit limb

$${\{ {u}_{i} , {v}_{i} \}}_{i = 1}^{m} ,$$

each point is projected onto a point on an image plane sᵢ by using an intrinsic camera calibration matrix K

$${s}_{i} = {K}^{- 1} [ \begin{matrix}{u}_{i} \\ {v}_{i} \\ 1\end{matrix} ] \qquad ( 4 )$$

Then, horizon-based OPNAV problem is transformed from being relative to a triaxial ellipsoid to a unit-sphere by converting sᵢ via

$${\overline{s}}_{i} = {QT}_{P}^{C} {s}_{i} \qquad ( 5 )$$

where Q=diag(1/a, 1/b, 1/c) with a, b, c, corresponding to body's principal axes. Finally, defining

$${\overline{s}}_{i}^{′} = {\overline{s}}_{i} / ‖ {\overline{s}}_{i} ‖ ,$$

the position of the spacecraft in the camera frame can be obtained by solving a linear least-squares problem

$$[ \begin{matrix}{{\overline{s}}_{1}^{′}}^{T} \\ {{\overline{s}}_{2}^{′}}^{T} \\ ⋮ \\ {{\overline{s}}_{m}^{′}}^{T}\end{matrix} ] n = Hn = {1}_{m \times 1} \qquad ( 6 )$$

Matrix H is a vertical concatenation of

$${\overline{s}}_{i}^{′ T} for i = 1 , … , m ,$$

and is introduced to facilitate an expression of the position measurement covariance later. The position vector of the spacecraft in the camera frame is given by

$${\hat{r}}_{C} = - {( {n}^{T} n - 1 )}^{- ( 1 / 2 )} {T}_{C}^{P} {Q}^{- 1} n \qquad ( 7 )$$

which can be transformed to the planet's principal axes frame via

$${\hat{r}}_{P} = {T}_{P}^{C} {\hat{r}}_{C} = - {( {n}^{T} n - 1 )}^{- ( 1 / 2 )} {Q}^{- 1} n \qquad ( 8 )$$

### A.2 Analytical Measurement Covariance Under Attitude Uncertainty

Following the Christian and Robinson algorithm, the position measurement covariance in the camera frame is obtained, assuming a noisy measurement quantified in terms of a “standard deviation of an observed horizon point in units of pixels”, σₚᵢₓ. This model assumes a perfect attitude knowledge and as a consequence a perfect transformation matrix from the camera frame to a planet's frame

$${T}_{C}^{P} ;$$

in reality, the camera will have some unknown misalignment, due to imperfection of the attitude information as well as the mounting process of hardware and vibration during launch of the spacecraft 101. As such, an expression for the position measurement covariance in the camera frame, Pᵣₚ, that incorporates both the error introduced by the imaging process as well as the imperfect attitude knowledge must be determined.

Starting from equation (8), taking its variation with respect to n and φ,

$$δ {r}_{P} = F δ n + G δϕ \qquad ( 9 )$$

where F is given by

$$F = - {( {n}^{T} n - 1 )}^{- ( 1 / 2 )} {Q}^{- 1} ( {I}_{3 \times 3} - \frac{{nn}^{T}}{{n}^{T} n - 1} ) \qquad ( 10 )$$

and G is given by

$$G = {T}_{P}^{C} [ {r}_{𝒞} \times ] \qquad ( 11 )$$

where [⋅×] is a skew-symmetric matrix following convention [a×]b=a×b, and dₓ is a pixel pitch in terms of pixels per radian. Then, the position measurement covariance of \hat{r}ₚ is given by

$${P}_{{r}_{P}} = 𝔼 [ δ {\hat{r}}_{P} δ {\hat{r}}_{P}^{T} ] = {FP}_{n} {F}^{T} + {GP}_{ϕ} {G}^{T} \qquad ( 12 )$$

where Pₙ is the covariance of the vector n, and P_{φ} is the covariance of the camera attitude. Expression for P_{φ} is given by

$${P}_{ϕ} = {σ}_{ϕ}^{2} {I}_{3 \times 3} . \qquad ( 13 )$$

An approximation for Pₙ is given by

$${P}_{n} = {( {H}^{T} {R}_{y} H )}^{- 1} \qquad ( 14 )$$

where R_{y} ∈ [symbol] ^{m×m} is a covariance of residuals of least-squares problem (6), given by

$${R}_{y} = diag ( {σ}_{{y}_{1}}^{2} , … , {σ}_{{y}_{m}}^{2} ) {σ}_{{y}_{i}} = {J}_{i} {QT}_{P}^{C} {R}_{S} {T}_{C}^{P} {Q}^{T} {J}_{i}^{T} \qquad ( 15 )$$

Rₛ is a covariance of horizon measurements, approximated by

$${R}_{s} \approx {( \frac{{σ}_{pix}}{{d}_{x}} )}^{2} [ \begin{matrix}1 & 0 & 0 \\ 0 & 1 & 0 \\ 0 & 0 & 0\end{matrix} ] \qquad ( 16 )$$

where σₚᵢₓ is a standard deviation of an observed horizon point in units of pixels, and Jᵢ is given by

$${J}_{i} = \frac{1}{‖ {\overline{s}}_{i} ‖} {n}^{T} ( {I}_{3 \times 3} - {\overline{s}}_{i}^{′} {\overline{s}}_{i}^{′ T} ) \qquad ( 17 )$$

The expression for the position measurement covariance (12) is validated using a Monte-Carlo experiment. At a fixed range of 70000 km from the Moon, each Monte-Carlo sample is computed as follows:
1. Generate random transformation matrix

$${T}_{P}^{C}$$

2. Generate 100 limb pixel coordinates

$${\{ {u}_{i} , {v}_{i} \}}_{i = 1}^{100}$$

along a true limb of the body (e.g., moon), located at equal angle intervals over a circular sector of 140°, perturbed by individually drawing a realization of σₚ
b.

$$\{ {u}_{i} , {v}_{i} \} = {\{ {u}_{i} , {v}_{i} \}}_{true} + \{ δ {u}_{i} , δ {v}_{i} \} i = 1 , … , m \qquad ( 18 )$$

where δuᵢ, δvᵢ~ [symbol] (0, σₚ)
3. Draw a realization of the attitude perturbation δT~ [symbol] (0, σ_{φ})
4. Compute true position in the planet frame

$${r}_{P} = δ {TT}_{P}^{C} [ \begin{matrix}0 \\ 0 \\ - 70000\end{matrix} ] \qquad ( 19 )$$

5. Compute position estimate from OPNAV using

$${T}_{P}^{C}$$

6. Compute error as \hat{r}_{P}-r_{P}

Points on the image that correspond to the lit limb of the Moon are found through a three-step process including (1) creating a mask centered around approximate lit limb locations found by scanning the image along a projected direction of an illumination vector of the Sun, followed by (2) applying a mask on edge points detected using a generic edge detection scheme such as Canny or Sobel edge detection, and finally (3) applying a Zernike moment-based refinement schemes to correct pixel-level point from (2) down to subpixel-level locations using local mini patches around each point.

### B. Navigation Filter

The operation of the spacecraft requires the use of a navigation filter (i.e., the probabilistic filter) for providing the best estimate of the spacecraft's state given measurements recursively. Due to non-negligible nonlinearity of the dynamics, Kalman filter is insufficient in predicting the state accurately. As such, approaches such as the extended Kalman filter (EKF) or the unscented Kalman filter (UKF) are appropriate, providing a trade-off between capturing the nonlinearity of the dynamics and associated computational cost. For the purpose of explanation the UKF is introduced in this section, as its prediction scheme will be relevant in the following section on design of the SK controller. Note that a measurement model from horizon-based optical measurement provides a position measurement, which is directly part of the state of the navigation filter; as such, measurement update follows a standard (linear) Kalman update.

### B.1. Prediction in Extended Kalman Filter

To account for uncertainties in (1), an additive process noise is included. A corresponding prediction step of the EKF is given by

$${\hat{θ}}_{j \vert j - 1} = {\hat{θ}}_{j - 1 \vert j - 1} + {\int }_{{t}_{j - 1}}^{{t}_{j}} f ( τ , {\hat{θ}}_{j - 1} ( τ ) ) d τ , \qquad ( 20 )$$

$${\sum }_{j \vert j - 1} = Φ ( {t}_{j} , {t}_{j - 1} ) {\sum }_{j - 1 \vert j - 1} {Φ ( {t}_{j} , {t}_{j - 1} )}^{T} + {Q}_{j} , \qquad ( 21 )$$

Process noise is modeled as an unbiased random process, with its covariance modeled using a sample period hⱼ=tⱼ−tⱼ₋₁ as

$${Q}_{j} = {σ}_{u}^{2} [ \begin{matrix}\frac{1}{3} {h}_{j}^{3} {I}_{3 \times 3} & \frac{1}{2} {h}_{j}^{2} {I}_{3 \times 3} \\ \frac{1}{2} {h}_{j}^{2} {I}_{3 \times 3} & {h}_{j} {I}_{3 \times 3}\end{matrix} ] , \qquad ( 22 )$$

where

$${σ}_{u}^{2}$$

is a diffusion coefficient to be adjusted to optimize performance of the navigation filter.

### B.2. Prediction in Unscented Kalman Filter

In case of the UKF, the prediction involves forming and propagating 2n+1 sigma points given by

$${𝒳}_{j - 1 \vert j - 1}^{( 0 )} = {\hat{θ}}_{j - 1 \vert j - 1} \qquad ( 23 )$$

$${𝒳}_{j - 1 \vert j - 1}^{( ℓ )} = {\hat{θ}}_{j - 1 \vert j - 1} + {\sqrt{n + λ} [ \sqrt{{\sum }_{j - 1 \vert j - 1}} ]}_{ℓ} ℓ = 1 , … , n \qquad ( 24 )$$

$${𝒳}_{j - 1 \vert j - 1}^{( ℓ + n )} = {\hat{θ}}_{j - 1 \vert j - 1} - {\sqrt{n + λ} [ \sqrt{{\sum }_{j - 1 \vert j - 1}} ]}_{ℓ} ℓ = 1 , … , n \qquad ( 25 )$$

where [symbol] corresponds to [symbol] ^{th} column of a matrix square root of Σ_{j-1|j-1}, and λ is given by

$$λ = {α}^{2} ( n + κ ) - n \qquad ( 26 )$$

Parameter a dictates a spread of the sigma points around the mean, usually chosen to be a small positive value, and κ is a secondary scaling parameter, usually set to 0. Each sigma point is propagated using the nonlinear dynamics

$${𝒳}_{j \vert j - 1}^{( i )} = {𝒳}_{j - 1 \vert j - 1}^{( ℓ )} + {\int }_{{t}_{j - 1}}^{{t}_{j}} f ( τ , {𝒳}_{j - 1 \vert j - 1}^{( ℓ )} ( τ ) ) d τ , ℓ = 0 , … , n \qquad ( 27 )$$

Finally, time update of the mean and the covariance are given by

$${\hat{θ}}_{j \vert j - 1} = {\sum }_{ℓ = 0}^{2 n} {W}_{ℓ}^{( m )} {𝒳}_{j \vert j - 1}^{( ℓ )} \qquad ( 28 )$$

$${Σ}_{j \vert j - 1} = {\sum }_{ℓ = 0}^{2 n} {W}_{ℓ}^{( c )} ( {𝒳}_{j \vert j - 1}^{( ℓ )} - {\hat{θ}}_{j \vert j - 1} ) {( {𝒳}_{j \vert j - 1}^{( ℓ )} - {\hat{θ}}_{j \vert j - 1} )}^{T} + {Q}_{j} \qquad ( 29 )$$

where Qⱼ is the process noise given by expression (22), while

$${W}_{i}^{( m )} and {W}_{ℓ}^{( c )}$$

are weights given by

$$\begin{matrix}{W}_{0}^{( m )} = \frac{λ}{n + λ} , \\ {W}_{0}^{( c )} = \frac{λ}{n + λ + ( 1 - {α}^{2} + β )} , \\ {W}_{ℓ}^{( m )} = \frac{1}{2 ( n + λ )} , ℓ = 1 , … , 2 n , \\ {W}_{ℓ}^{( c} = \frac{1}{2 ( n + λ )} , ℓ = 1 , … , 2 n ,\end{matrix} \qquad ( 30 )$$

where β is an additional parameter to incorporate prior knowledge of \hat{θ}; β=2 is optimal assuming it is Gaussian.

### B.3. Measurement Update

The position measurements are modeled as direct position measurements with additive Gaussian noise given by

$${y}_{j} = E {θ}_{j} + {R}_{j} , {R}_{j} ∼ 𝒩 ( 0 , {R}_{j} ) , E = [ \begin{matrix}{I}_{3 \times 3} & {0}_{3 \times 3}\end{matrix} ] . \qquad ( 31 )$$

Resulting linear update step of the navigation filter is given by

$${K}_{j} = {Σ}_{j \vert j - 1} {{E}^{T} ( E {Σ}_{j \vert j - 1} {E}^{T} + {R}_{j} )}^{- 1} , \qquad ( 32 )$$

$${\hat{θ}}_{j \vert j} = {\hat{θ}}_{j \vert j - 1} + {K}_{j} ( {y}_{j} - E {\hat{θ}}_{j \vert j - 1} ) , \qquad ( 33 )$$

$${Σ}_{j \vert j} = ( I - {K}_{j} E ) {{Σ}_{j \vert j - 1} ( I - {K}_{j} E )}^{T} + {K}_{j} {R}_{j} {K}_{j}^{T} , \qquad ( 34 )$$

where measurements yⱼ and measurement noise covariance Rⱼ are obtained from equations (8) and (12), respectively from the horizon-based OPNAV algorithm.

### Motion Control

There exists a multitude of controllers proposed for purpose of station keeping (SK). The present disclosure uses the xz-plane crossing control which is a SK control scheme.

### Targeting State

Consider the spacecraft at to at some state (estimate) θ₀∈ [symbol] ⁶. The xz-plane crossing control must bring a subset of the propagated state at time t_{f}, ψ(t_{f})∈ [symbol] ^{m} where m≤6, to an m-dimensional ellipsoid from a reference target ψ̅(t̅)∈ [symbol] ^{m} at time t̅, with radii ϵ_{j,tol} for j=0, . . . , m−1. While integration of the dynamics from time t₀ to t_{f} is typically done in an inertial frame [symbol] _{Inr}, the targeted state ψ and ψ̅ may be components in another frame [symbol] _{B}.

Note that in general, t̅≠t_{f}, as a targeted state (i.e., the mean targeted state) is not defined based on time; this is an important distinction of this control scheme. The xz-plane crossing control gets its name from the fact that the targeted state is defined based on an event where the desired trajectory 107 crosses the xz-plane near the Moon, in an Earth-Moon rotating frame.

An optimal control maneuver that brings the spacecraft to the m-dimensional ball centered at ψ̅ (t_{f}) is computed by solving the following nonlinear program (NLP):

$${min}_{u} ‖ u {‖}_{2} such that \qquad ( 35 )$$

$$\vert {ψ}^{B} ( {t}_{f} ) - {\overline{ψ}}^{B} \vert \leq {v}_{x , tol} \qquad ( 36 )$$

where an absolute value on constraint (36) is applied component-wise. Final targeted state ψ^{B} (t_{f}) is a subset of a final state estimate θ^{B}(t_{f}) transformed from the inertial frame to frame F_{B}, obtained by propagating the nonlinear dynamics with controls u=vec(u₀, . . . , u_{K-1})

$${θ}^{B} ( {t}_{f} ) = {T}_{B}^{I n r} {\int }_{{t}_{o}}^{{t}_{f}} f [ τ , {θ}_{0} + v e c ( {0}_{3 \times 1} , u ) ] d τ \qquad ( 37 )$$

where

$${T}_{B}^{I n r} ∈ {ℝ}^{6 \times 6}$$

is the transformation matrix from frames [symbol] _{Inr} to [symbol] _{B}.

Instead of targeting an immediate perilune, N^{th} perilune downstream is chosen. The choice of N impacts the performance of the xz-plane crossing control, where a trade-off must be made between how accurately the state may be propagated and how far downstream targeting event is located.

Finally, one is left with the choice of which m state components to target, the frame in which these state components are represented, and a tolerance on tightness of the targeting. Some embodiments are based on the recognition that that targeting x-axis velocity in the Earth-Moon rotating frame, denoted hereafter by

$${v}_{x}^{E M} ,$$

is sufficient for tracking the desired trajectory under reasonable levels of errors and uncertainties. Some embodiments are based on the understanding that nature of the xz-plane crossing control using

$${v}_{x}^{E M}$$

alone as a tracking controller that tracks only the state components necessary to establish stabilizability. As such, [symbol] _{B} is the Earth-Moon rotating frame [symbol] _{EM}, and

$${ψ}^{B} = {v}_{x}^{E M} .$$

Then, constraint (36) is replaced by

$$\vert {v}_{x}^{E M} ( {t}_{f} ) - {\overline{v}}_{x}^{E M} \vert \leq {v}_{x , tol} \qquad ( 38 )$$

where

$${v}_{x}^{E M} ( {t}_{f} )$$

is part of the final state θ^{EM}(t_{f}) obtained by transforming the solution to initial value problem (37), and

$${\overline{v}}_{x}^{E M}$$

is reference x-axis velocity in instantaneous Earth-Moon rotating frame at a targeted perilune.

### B. Maneuver Placement

FIG. 5B illustrates NRHO shown with instantaneous true anomaly for a duration of 10 revolutions, seen from near-side of the Moon (Earth-side observer) in the Earth-Moon rotating frame, according to some embodiments of the present disclosure. A location along the NRHO where the control is to be conducted is parameterized in terms of the instantaneous true anomaly. The particularly high sensitivity of the dynamics near perilune on the NRHO is unsuitable for station-keeping; as such, the control is to be located at or near the apolune, at a true anomaly of around 180°.

C. xz-plane Crossing Control via Differential Correction

Differential corrector (DC) approach involves recasting problem (35), (36) as an under-determined root-finding problem with a shooting function F: [symbol] ³→ [symbol] , seeking F(u)=0 where

$$F ( u ) = {v}_{x}^{E M} ( {t}_{f} ) - {\overline{v}}_{x}^{E M} \qquad ( 39 )$$

Employing an iterative scheme such as a generalized Newton-Raphson method, one may employ a minimum-norm update given for iteration i to i+1 by

$${u}^{( i + 1 )} = {u}^{( i )} - D {{F}^{T} ( {u}^{( i )} ) [ D {F}^{T} ( {u}^{( i )} ) D F ( {u}^{( i )} ) ]}^{- 1} F ( {u}^{( i )} ) \qquad ( 40 )$$

where DF is Jacobian ∂F/∂u. Since u is essentially a perturbation on the initial velocity δv₀, this partial can be computed from the STM as

$$\frac{\partial F}{\partial u} = {( {T}_{EM}^{Inr} [ \begin{matrix}{Φ}_{rv} ( {t}_{f} , {t}_{0} ) \\ {Φ}_{v v} ( {t}_{f} , {t}_{0} )\end{matrix} ] )}_{[ 4 , : ]} = {( {T}_{E M}^{I n r} {Φ}_{[ : , 4 : 6 ]} ( {t}_{f} , {t}_{0} ) )}_{[ 4 , : ]} \qquad ( 41 )$$

where Φ_{[:,4:6]} is the last three columns of the STM and (⋅)_{[4;]} denotes the fourth row of the matrix. While DC approach does not directly minimize control effort, it still yields adequate performance as the minimum-norm update (40) promotes successive updates from u^{k} to u^{k+1} to be as small as possible.

D. xz-plane Crossing Control as a Sequentially Linearized Minimization Problem

An alternate approach is to sequentially solve an approximate version of the NLP (35), (36). Specifically, (37) is replaced via a linearized expression

$${θ}^{E M} ( {t}_{f} ) = {T}_{E M}^{I n r} ( {\int }_{{t}_{0}}^{{t}_{f}} f ( τ , {θ}_{0} ) d τ + [ \begin{matrix}{Φ}_{rv} ( {t}_{f} , {t}_{0} ) \\ {Φ}_{v v} ( {t}_{f} , {t}_{0} )\end{matrix} ] u ) = {T}_{E M}^{I n r} {θ}_{f , 0} + Bu \qquad ( 42 )$$

where θ_{f,0} is the final state at t_{f} if no control is executed at t₀, and B is given by

$$B = {T}_{E M}^{I n r} [ \begin{matrix}{Φ}_{rv} ( {t}_{f} , {t}_{0} ) \\ {Φ}_{v v} ( {t}_{f} , {t}_{0} )\end{matrix} ] = {T}_{E M}^{I n r} {Φ}_{[ : , 4 : 6 ]} ( {t}_{f} , {t}_{0} ) \qquad ( 43 )$$

Then, denoting

$${v}_{x , 0}^{E M} ( {t}_{f} ) = {( {T}_{E M}^{I n r} {θ}_{f , 0} )}_{[ 4 ]} ,$$

the linearized problem is given by

$${min}_{u} {‖ u ‖}_{2} \qquad ( 44 )$$

$$suchthat \vert {v}_{x , 0}^{E M} ( {t}_{f} ) + {B}_{[ 4 , : ]} u - {\overline{v}}_{x}^{E M} \vert \leq {v}_{x , tol}^{′} \qquad ( 45 )$$

where (⋅)_{[4]} denotes a fourth component of the vector. Constraint (45) is bounded by

$${v}_{x , tol}^{′} ,$$

which is given in terms of original targeting tolerance v_{x,tol} by

$${v}_{x , tol}^{′} = {sv}_{x , tol}$$

where 0<s<1 is a safety factor, for example, set to s=0.9. Setting

$${v}_{x , tol}^{′} < {v}_{x , tol}$$

ensures the constraint (45) is achieved by sequentially updating u with a solution of the linearized problem (44), (45).

Solving minimization problem given by (44), (45) is different from solving the root-finding problem (39) in two regards. Firstly, the dynamics have been linearized using the STM in (42); as such, the solution u may not satisfy the constraint when propagated with the nonlinear (37). For station-keeping approximation, the control that is sought is typically small in magnitude, and linear approximation holds relatively well. Some embodiments are based on the recognition that a few iterations (2~3 in practice) solving (44), (45) by updating θ_{f,0} and B may be necessary to incrementally obtain an aggregate control ū. Specifically, after the i^{th} iteration solving the linearized problem, θ_{f,0} is replaced by θ_{f,0}←θ_{f,0}+u⁽ⁱ⁾ where u⁽ⁱ⁾ is a solution from the i^{th} iteration, and B is reconstructed using an updated initial state for the i+1th iteration. Secondly, because this is a minimization of ∥u∥₂, the resulting control u is the minimum feasible u that simultaneously ensures the final

$${v}_{x}^{E M}$$

is within

$${v}_{x , tol}^{′}$$

of the targeted value

$${\overline{v}}_{x}^{E M}$$

within the aforementioned linear approximated dynamics (42).

For problem (42), its optimal solution may be obtained analytically by observing that it is equivalent to determining projection of the origin to an intersection of two half-spaces. First, note that the control u satisfying the constraint (45) is a vector y that belongs to the intersection of two half-spaces given by

$$\begin{matrix}C = \begin{matrix}\{ y \vert {B}_{[ 4 , : ]} y \leq {v}_{x , tol}^{′} - {v}_{x , 0}^{E M} ( {t}_{f} ) + {\overline{v}}_{x}^{E M} \} ⋂ \\ \{ y \vert - {B}_{[ 4 , : ]} y \leq {v}_{x , tol}^{′} + {v}_{x , 0}^{E M} ( {t}_{f} ) - {\overline{v}}_{x}^{E M} \}\end{matrix} \\ = \{ y \vert {ξ}_{1}^{T} y \leq {η}_{1} \} ⋂ \{ y \vert {ξ}_{2}^{T} y \leq {η}_{2} \}\end{matrix} \qquad ( 46 )$$

where the variables

$${ξ}_{1}^{T} = {B}_{[ 4 , : ]} \qquad ( 47 )$$

$${ξ}_{2}^{T} = - {B}_{[ 4 , : ]} \qquad ( 48 )$$

$${η}_{1} = {v}_{x , tol}^{′} - {v}_{x , 0}^{E M} ( {t}_{f} ) + {\overline{v}}_{x}^{E M} \qquad ( 49 )$$

$${η}_{2} = {v}_{x , tol}^{′} + {v}_{x , 0}^{E M} ( {t}_{f} ) - {\overline{v}}_{x}^{E M} \qquad ( 50 )$$

have been introduced to simplify notations. Then, an expression for a projection of y onto C is given by

$${P}_{C} y = y - {ν}_{1} {ξ}_{1} - {ν}_{2} {ξ}_{2} \qquad ( 51 )$$

where exactly one of the following holds:

$$[ \begin{matrix}{ν}_{1} \\ {ν}_{2}\end{matrix} ] = \{ \begin{matrix}[ \begin{matrix}0 \\ 0\end{matrix} ] & {ξ}_{1}^{T} y \leq {η}_{1} and {ξ}_{2}^{T} y \leq {η}_{2} \\ [ \begin{matrix}\frac{\begin{matrix}( {‖ {ξ}_{2} ‖}^{2} ( {y}^{T} {ξ}_{1} > {η}_{1} ) - \\ {ξ}_{1}^{T} {ξ}_{2} ( {y}^{T} {ξ}_{2} - {η}_{2} )\end{matrix}}{( ‖ {ξ}_{1}^{2} ‖ {‖ {ξ}_{2} ‖}^{2} - {\vert {ξ}_{1}^{t} {ξ}_{2} \vert}^{2} )} \\ \frac{\begin{matrix}( {‖ {ξ}_{1} ‖}^{2} ( {y}^{T} {ξ}_{2} > {η}_{2} ) - \\ {ξ}_{1}^{T} {ξ}_{2} ( {y}^{T} {ξ}_{1} - {η}_{1} )\end{matrix}}{( ‖ {ξ}_{1}^{2} ‖ {‖ {ξ}_{2} ‖}^{2} - {\vert {ξ}_{1}^{t} {ξ}_{2} \vert}^{2} )}\end{matrix} ] & \begin{matrix}{‖ {ξ}_{2} ‖}^{2} ( {y}^{T} {ξ}_{1} > {η}_{1} ) > {ξ}_{1}^{T} {ξ}_{2} ( {y}^{T} {ξ}_{2} - {η}_{2} ) ) and \\ {‖ {ξ}_{1} ‖}^{2} ( {y}^{T} {ξ}_{2} > {η}_{2} ) > {ξ}_{1}^{T} {ξ}_{2} ( {y}^{T} {ξ}_{1} - {η}_{1} )\end{matrix} \\ [ \begin{matrix}0 \\ \frac{{y}^{T} {ξ}_{2} - {η}_{2}}{{‖ {ξ}_{2} ‖}^{2}}\end{matrix} ] & \begin{matrix}{y}^{T} {ξ}_{2} > {η}_{2} and \\ {‖ {ξ}_{2} ‖}^{2} ( {y}^{t} {ξ}_{1} - {η}_{1} ) \leq {ξ}_{1}^{T} {ξ}_{2} ( {y}^{T} {ξ}_{2} - {η}_{2} )\end{matrix} \\ [ \begin{matrix}\frac{{y}^{T} {ξ}_{1} - {η}_{1}}{{‖ {ξ}_{1} ‖}^{2}} \\ 0\end{matrix} ] & \begin{matrix}{y}^{T} {ξ}_{1} > {η}_{1} \\ and {‖ {ξ}_{1} ‖}^{2} ( {y}^{T} {ξ}_{2} - {η}_{2} ) \leq {ξ}_{1}^{T} {ξ}_{2} ( {y}^{T} {ξ}_{1} - {η}_{1} )\end{matrix}\end{matrix} \qquad ( 52 )$$

Since control inputs are minimized, i.e., minimize ∥u∥₂, choosing y=0_{3×1} in equation (51) yields an optimal solution u*=P_{C}0_{3×1} to problem (44), (45).

In summary, the sequential linearization approach solves the NLP (35), (36). by sequentially building the linearized problem (44), (45) and computing its analytical solution via equation (51). The overall procedure is termed as “sequentially linearized minimization problem” (SLMP).

### E. Mean State Targeting via Unscented Transform

Some embodiments are based on the recognition that the xz-plane crossing control involves targeting the state ψ(t_{f}), obtained by simply propagating a current state estimate. This may be understood as the prediction step of the EKF, where the best estimate of a future state is obtained by propagating the current state estimate forward in time. While filter performances for the sake of state estimation have resulted in no apparent results between the EKF and the UKF, the state estimation involved for the control is over a significantly longer time, across multiple revolutions along the periodic orbit; as such, it may be possible that utilizing a UKF style prediction of the future state can better capture the nonlinearity involved. Thus, some embodiments consider a control scheme which, utilizing the filter's covariance estimates, aims to steer the mean targeted state [symbol] [ψ^{B}(t_{f})] computed via the unscented transform. The resulting NLP is given by

$${min}_{u} {‖ u ‖}_{2} \qquad ( 53 )$$

$$suchthat \vert 𝔼 [ {ψ}^{B} ( {t}_{f} ) ] - {\overline{ψ}}^{B} \vert \leq {v}_{x , tol} \qquad ( 54 )$$

The mean targeted state [symbol] [ψ^{B}(t_{f})] under no control maneuver can be approximated using the unscented transform. The mean targeted state at time t_{f} is approximated by

$$𝔼 [ {ψ}_{0}^{E M} ( {t}_{f} ) ] \approx {( {\sum }_{ℓ = 0}^{2 n} {W}_{m}^{( ℓ )} {𝒴}^{( ℓ )} )}_{m} \qquad ( 55 )$$

where [symbol] is given by

$${𝒴}^{( ℓ )} = {T}_{E M}^{I n r} ( {𝒳}_{j - 1 \vert j - 1}^{( ℓ )} + {\int }_{{t}_{j - 1}}^{{t}_{j}} f ( τ , {𝒳}_{j - 1 \vert j - 1}^{( ℓ )} ( τ ) ) d τ ) , ℓ = 0 , … , n \qquad ( 56 )$$

with sigma points computed by expression (23)-(25). By replacing

$${v}_{x}^{E M} ( {t}_{f} )$$

in equation (39) or

$${v}_{x , 0}^{E M} ( {t}_{f} )$$

in equation (45) with

$$𝔼 [ {ψ}_{0}^{E M} ( {t}_{f} ) ] ,$$

both the DC and SLMP approaches may be augmented to target the mean state; these augmented approaches are referred to as UT-DC and UT-SLMP, respectively.

### F. Trigger Condition and Targeting Tolerance Tuning

At each control action true anomaly, a trigger condition is used to determine whether the control should be executed. Such a condition is based on an indicator that quantifies a divergence of the state estimate from the desired trajectory 107; in the case of the xz-plane crossing control, the indicator is to use a difference in magnitude of

$${v}_{x}^{E M}$$

at N^{th} perilune with respect to the desired trajectory 107. A threshold is defined above which warrants a control maneuver as v_{x,trig}, such that a control is triggered if

$$\vert {v}_{x}^{E M} - {\overline{v}}_{x}^{E M} \vert \geq {v}_{x , t r i g} .$$

While both the DC and SLMP approaches are affected by this dead-band v_{x,trig} at which the is necessitated, the SLMP approach also requires consideration of tuning v_{x,tol} appropriately.

When employing DC, an actual targeting violation

$$\vert {v}_{x}^{E M} - {\overline{v}}_{x}^{E M} \vert$$

achieved is uncorrelated to v_{x,tol} due to quadratic convergence nature; as such, depending on the realization of the state at control epoch, the DC approach may sometimes converge to

$$\vert {v}_{x}^{E M} - {\overline{v}}_{x}^{E M} \vert ≪ {v}_{x , tol} ,$$

and at other times converge to

$$\vert {v}_{x}^{E M} - {\overline{v}}_{x}^{E M} \vert {\approx }^{<} {v}_{x , tol} .$$

Thus, as long as an appropriate v_{x,trig} is chosen, setting v_{x,tol}=v_{x,trig} or otherwise plays a relatively small importance. Such an arbitrary nature of the DC converging at different levels of

$$\vert {v}_{x}^{E M} - {\overline{v}}_{x}^{E M} \vert$$

is an inherent hysteresis mechanism.

In contrast, the SLMP being a constrained minimization problem consistently aims to achieve

$$\vert {v}_{x}^{E M} - {\overline{v}}_{x}^{E M} \vert {\approx }^{<} {v}_{x , tol} .$$

As such, v_{x,tol} plays a direct, concrete role in dictating how well the motion controller 117 is tasked at tracking the desired trajectory 107; a tight v_{x,tol} results in expending more control effort on average to align the spacecraft 101 closely to the desired trajectory 107, while a relaxed v_{x,tol} results in the opposite behavior.

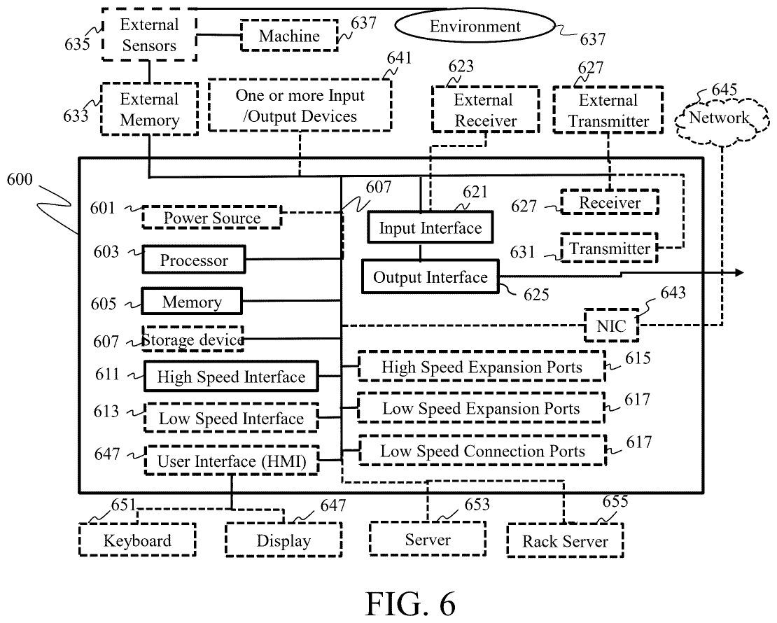

FIG. 6 is a schematic illustrating by non-limiting example a computing apparatus for implementing the methods and the systems of the present disclosure. The computing device 600 can include a power source 601, a processor 603, a memory 605, a storage device 607, all connected to a bus 609. Further, a high-speed interface 611, a low-speed interface 613, high-speed expansion ports 615 and low speed connection ports 617, can be connected to the bus 609. In addition, a low-speed expansion port 619 is in connection with the bus 609. Further, an input interface 621 can be connected via the bus 609 to an external receiver 623 and an output interface 625. A receiver 627 can be connected to an external transmitter 629 and a transmitter 631 via the bus 609. Also connected to the bus 609 can be an external memory 633, external sensors 635, machine(s) 637, and an environment 639. Further, one or more external input/output devices 641 can be connected to the bus 609. A network interface controller (NIC) 643 can be adapted to connect through the bus 609 to a network 645, wherein data or other data, among other things, can be rendered on a third-party display device, third party imaging device, and/or third-party printing device outside of the computer device 600.

The memory 605 can store instructions that are executable by the computer device 600, historical data, and any data that can be utilized by the methods and systems of the present disclosure. The memory 605 can include random access memory (RAM), read only memory (ROM), flash memory, or any other suitable memory systems. The memory 605 can be a volatile memory unit or units, and/or a non-volatile memory unit or units. The memory 605 may also be another form of computer-readable medium, such as a magnetic or optical disk.

The storage device 607 can be adapted to store supplementary data and/or software modules used by the computer device 600. For example, the storage device 607 can store historical data and other related data as mentioned above regarding the present disclosure. Additionally, or alternatively, the storage device 607 can store historical data like data as mentioned above regarding the present disclosure. The storage device 607 can include a hard drive, an optical drive, a thumb-drive, an array of drives, or any combinations thereof. Further, the storage device 607 can contain a computer-readable medium, such as a floppy disk device, a hard disk device, an optical disk device, or a tape device, a flash memory or other similar solid-state memory device, or an array of devices, including devices in a storage area network or other configurations. Instructions can be stored in an information carrier. The instructions, when executed by one or more processing devices (for example, the processor 603), perform one or more methods, such as those described above.

The computing device 600 can be linked through the bus 609, optionally, to a display interface or user Interface (HMI) 647 adapted to connect the computing device 600 to a display device 649 and a keyboard 651, wherein the display device 649 can include a computer monitor, camera, television, projector, or mobile device, among others. In some implementations, the computer device 600 may include a printer interface to connect to a printing device, wherein the printing device can include a liquid inkjet printer, solid ink printer, large-scale commercial printer, thermal printer, UV printer, or dye-sublimation printer, among others.

The high-speed interface 611 manages bandwidth-intensive operations for the computing device 600, while the low-speed interface 613 manages lower bandwidth-intensive operations. Such allocation of functions is an example only. In some implementations, the high-speed interface 611 can be coupled to the memory 605, the user interface (HMI) 647, and to the keyboard 651 and the display 649 (e.g., through a graphics processor or accelerator), and to the high-speed expansion ports 615, which may accept various expansion cards via the bus 609. In an implementation, the low-speed interface 613 is coupled to the storage device 607 and the low-speed expansion ports 617, via the bus 609. The low-speed expansion ports 617, which may include various communication ports (e.g., USB, Bluetooth, Ethernet, wireless Ethernet) may be coupled to the one or more input/output devices 641. The computing device 600 may be connected to a server 653 and a rack server 655. The computing device 600 may be implemented in several different forms. For example, the computing device 600 may be implemented as part of the rack server 655.

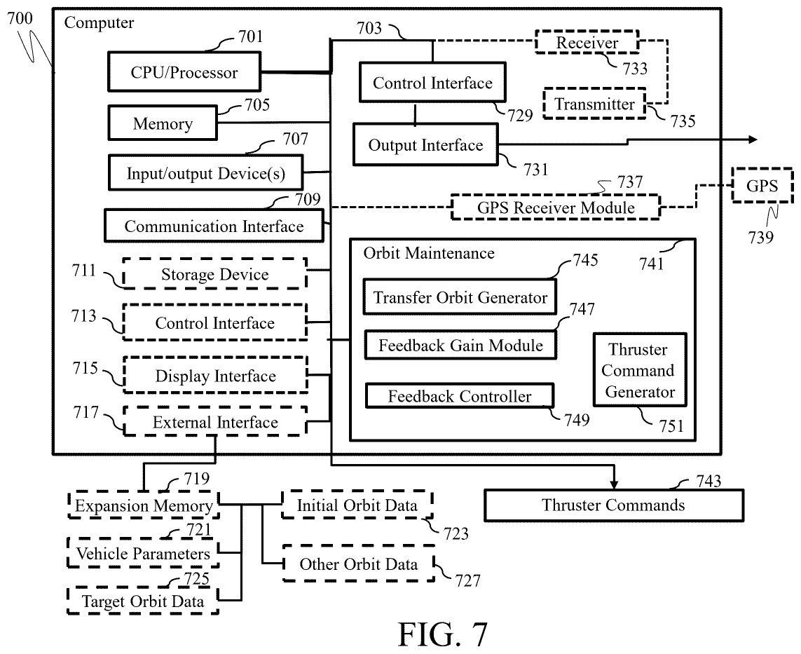

FIG. 7 is a schematic diagram illustrating some components used for implementing the methods and the systems of the present disclosure. For example, a computer 700 can be adapted for controlling the operation of the spacecraft 405 in the multi-object celestial system while ensuring passive safety. A CPU or processor(s) 701 can be connected via a bus system 703 to a memory 705, input/output devices 707 and a communication interface 709. Also, connected to the bus system 703 can be a storage device 711, a control interface 713, display interface 715, and an external interface 717.

The external interface 717 can be connected to an expansion memory 719, vehicle parameters 721 (i.e. spacecraft specifications, thruster specifications, size, weight, etc.), initial orbit data 723 (i.e. time, date, parameters including altitude, inclination, eccentricity, etc.), target orbit data 725, and other orbit data 727 (i.e. unique orbit data). The bus system 703 can also connect a control interface 729, an output interface 731, a receiver 733 and a transmitter 735. Further, the bus system 703 can connect a GPS receiver module 737 to a GPS 739. The computer 700 includes an orbit maintenance module 741. The orbit maintenance module 741 may output thruster commands 743. The orbit maintenance module 741 includes a transfer orbit generator 745, a feedback gain module 747, a feedback controller 749, and a thruster command generator 751.

The computer 700 can be a server or a desktop, a laptop, a mobile or other computer device or system with one or more processors 701. The processor 701 may be a central processing unit adapted for accessing code in the form of the transfer orbit generator 745 in the memory 705 or storage device 711 of the computer 700 (or in an expansion memory 719). Contemplated are external storage devices if further required depending upon the specific design and aspect of an intended hardware and goal implementation, according aspects related to the systems and the methods of the present disclosure. For example, the computer 700 can be used to implement the steps of the systems and methods, where the memory 705, and/or storage device 711 can store data.

The stored data in the memory 705 can include executable modules, vehicle data and historical space data. For example, the vehicle data can include specifications of the spacecraft, dimensions, weight, performance data under varied conditions including gravitation forces, and other perturbations, i.e. complex motion(s) of a massive body subject to forces other than the gravitational attraction of a single other massive body in space.

Further, the vehicle data can include data related to aspects related to vehicle dynamics associated with one or more of the multi-variables, i.e. (1) unusual orbital characteristics of a celestial body, i.e. a natural object which is located outside of Earth's atmosphere, such as the Moon, the Sun, an asteroid, planet, or star; (2) unusual orbital motion the celestial body; (3) celestial body's unusually close orbit around another celestial body; and (4) other known perturbations. The space data can include data related to celestial body(s) system, past missions to celestial body(s) and any other data related to space, the spacecraft and planning orbital designs to other celestial bodies in the universe. For example, the space data can include data about the moons of celestial body(s), such as characteristics of celestial body(s) that can be taken into consideration in developing orbital designs from an initial celestial body(s) orbit to a similar target celestial body(s) orbit.

The processor 701 of the computer 700 may be two or more processors depending upon the specific application. For example, some steps may require a separate processor to ensure a specific processing time or processing speed associated with the systems and methods of the present disclosure. The receiver 733 or input interface can receive space data that may be up-to-date space data, obtained from either an Earth Mission Control Center or sensors associated with the spacecraft, or some other location, after the stored historical space data stored in the memory 705. The receiver 733 and the transmitter 735 can provide a wireless venue for receiving and sending data to, for example, an Earth Mission Control Center, or some other destination. The GPS receiver module 737 connected to the GPS 739 can be used for navigation related aspects. The computer 700 may further include external devices, control interfaces, displays, sensors, machines, etc., that are contemplated for uses related to the systems and methods of the present disclosure.

The description provides exemplary embodiments only, and is not intended to limit the scope, applicability, or configuration of the disclosure. Rather, the following description of the exemplary embodiments will provide those skilled in the art with an enabling description for implementing one or more exemplary embodiments. Contemplated are various changes that may be made in the function and arrangement of elements without departing from the spirit and scope of the subject matter disclosed as set forth in the appended claims.

Specific details are given in the following description to provide a thorough understanding of the embodiments. However, understood by one of ordinary skill in the art can be that the embodiments may be practiced without these specific details. For example, systems, processes, and other elements in the subject matter disclosed may be shown as components in block diagram form in order not to obscure the embodiments in unnecessary detail. In other instances, well-known processes, structures, and techniques may be shown without unnecessary detail in order to avoid obscuring the embodiments. Further, like reference numbers and designations in the various drawings indicated like elements.

Also, individual embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process may be terminated when its operations are completed, but may have additional steps not discussed or included in a figure. Furthermore, not all operations in any particularly described process may occur in all embodiments. A process may correspond to a method, a function, a procedure, a subroutine, a subprogram, etc. When a process corresponds to a function, the function's termination can correspond to a return of the function to the calling function or the main function.

Furthermore, embodiments of the subject matter disclosed may be implemented, at least in part, either manually or automatically. Manual or automatic implementations may be executed, or at least assisted, through the use of machines, hardware, software, firmware, middleware, microcode, hardware description languages, or any combination thereof. When implemented in software, firmware, middleware or microcode, the program code or code segments to perform the necessary tasks may be stored in a machine readable medium. A processor(s) may perform the necessary tasks.

Various methods or processes outlined herein may be coded as software that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine. Typically, the functionality of the program modules may be combined or distributed as desired in various embodiments.

Embodiments of the present disclosure may be embodied as a method, of which an example has been provided. The acts performed as part of the method may be ordered in any suitable way. Accordingly, embodiments may be constructed in which acts are performed in an order different than illustrated, which may include performing some acts concurrently, even though shown as sequential acts in illustrative embodiments.

Further, embodiments of the present disclosure and the functional operations described in this specification can be implemented in digital electronic circuitry, in tangibly-embodied computer software or firmware, in computer hardware, including the structures disclosed in this specification and their structural equivalents, or in combinations of one or more of them. Further some embodiments of the present disclosure can be implemented as one or more computer programs, i.e., one or more modules of computer program instructions encoded on a tangible non transitory program carrier for execution by, or to control the operation of, data processing apparatus. Further still, program instructions can be encoded on an artificially generated propagated signal, e.g., a machine-generated electrical, optical, or electromagnetic signal, which is generated to encode information for transmission to suitable receiver apparatus for execution by a data processing apparatus. The computer storage medium can be a machine-readable storage device, a machine-readable storage substrate, a random or serial access memory device, or a combination of one or more of them.

According to embodiments of the present disclosure the term “data processing apparatus” can encompass all kinds of apparatus, devices, and machines for processing data, including by way of example a programmable processor, a computer, or multiple processors or computers. The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, or a combination of one or more of them.

A computer program (which may also be referred to or described as a program, software, a software application, a module, a software module, a script, or code) can be written in any form of programming language, including compiled or interpreted languages, or declarative or procedural languages, and it can be deployed in any form, including as a stand-alone program or as a module, component, subroutine, or other unit suitable for use in a computing environment. A computer program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub programs, or portions of code.

A computer program can be deployed to be executed on one computer or on multiple computers that are located at one site or distributed across multiple sites and interconnected by a communication network. Computers suitable for the execution of a computer program include, by way of example, can be based on general or special purpose microprocessors or both, or any other kind of central processing unit. Generally, a central processing unit will receive instructions and data from a read only memory or a random access memory or both. The essential elements of a computer are a central processing unit for performing or executing instructions and one or more memory devices for storing instructions and data.

Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

Although the present disclosure has been described with reference to certain preferred embodiments, it is to be understood that various other adaptations and modifications can be made within the spirit and scope of the present disclosure. Therefore, it is the aspect of the append claims to cover all such variations and modifications as come within the true spirit and scope of the present disclosure.

We claim:

1. A spacecraft control system, comprising:
a state estimator configured to:
receive data indicative of measurements of a sequence of positions of the spacecraft;
generate, based on the received data, a position measurement of the spacecraft and a covariance of the position measurement; and
based on the position measurement and the covariance of the position measurement, estimate a mean and a covariance of a state of the spacecraft using a probabilistic filter, wherein the state of the spacecraft includes a position and a velocity of the spacecraft; and
a motion controller employing xz-plane crossing control configured to:
determine a mean targeted state of the spacecraft using an unscented transform (UT) on the mean and the covariance of the state of the spacecraft;
determine control commands that steer the spacecraft from the mean targeted state to a reference state of the spacecraft, wherein the reference state includes a crossing point where a desired trajectory of the spacecraft and xz-plane intersect; and
control one or more actuators of the spacecraft based on the control commands to track the desired trajectory.

2. The spacecraft control system of claim 1, wherein the state estimator is further configured to receive the data indicative of the measurements of the sequence of positions of the spacecraft from one or a combination of Earth-based transmissions and optical imaging.

3. The spacecraft control system of claim 1, wherein the state estimator is further configured to receive the data indicative of the measurements of the sequence of positions of the spacecraft using only optical imaging.

4. The spacecraft control system of claim 1, wherein the covariance of the position measurement includes a term that captures sensitivity of the position measurement with respect to an attitude error of the spacecraft.

5. The spacecraft control system of claim 1, wherein the measurements of the sequence of positions of the spacecraft include optimal images captured by an imaging system of the spacecraft at a perilune point on the desired trajectory.

6. The spacecraft control system of claim 5, wherein the optimal images are captured by the imaging system of the spacecraft at a location on the desired trajectory selected based on at least one of a range from moon, illumination conditions, and an operational constraint of the spacecraft.

7. The spacecraft control system of claim 1, wherein the motion controller is further configured to execute the control commands at an optimal control point on the desired trajectory at which a dynamic stability of the spacecraft and a state estimation error are balanced.

8. The spacecraft control system of claim 7, wherein a cumulative propellant cost of the spacecraft is minimum at the optimal control point.

9. The spacecraft control system of claim 7, wherein the optimal control point lies between a perilune point and an apolune point on the desired trajectory.

10. The spacecraft control system of claim 1, wherein multiple control maneuvers of the spacecraft are planned at multiple pre-specified locations on the desired trajectory.

11. The spacecraft control system of claim 10, wherein the multiple pre-specified locations on the desired trajectory at which the multiple control maneuvers of the spacecraft are planned correspond to points on the desired trajectory where the covariance of the state of the spacecraft is minimal.

12. The spacecraft control system of claim 1, wherein the probabilistic filter is an extended Kalman filter (EKF).

13. The spacecraft control system of claim 1, wherein the probabilistic filter is an unscented Kalman filter.

14. A spacecraft control method, comprising:
receiving data indicative of measurements of a sequence of positions of the spacecraft;
generating, based on the received data, a position measurement of the spacecraft and a covariance of the position measurement;
based on the position measurement and the covariance of the position measurement, estimating a mean and a covariance of a state of the spacecraft using a probabilistic filter, wherein the state of the spacecraft includes a position and a velocity of the spacecraft;
determining a mean targeted state of the spacecraft using an unscented transform (UT) on the mean and the covariance of the state of the spacecraft;
determining control commands that steer the spacecraft from the mean targeted state to a reference state of the spacecraft, wherein the reference state includes a crossing point where a desired trajectory of the spacecraft and xz-plane intersect; and
controlling one or more actuators of the spacecraft based on the control commands to track the desired trajectory.

15. The method of claim 14, wherein the method further comprises receiving the data indicative of the measurements of the sequence of positions of the spacecraft from one or a combination of Earth-based transmissions and optical imaging.

16. The method of claim 14, wherein the method further comprises receiving the data indicative of the measurements of the sequence of positions of the spacecraft using only optical imaging.

17. The method of claim 14, wherein the covariance of the position measurement includes a term that captures sensitivity of the position measurement with respect to an attitude error of the spacecraft.

19. The method of claim 14, wherein the measurements of the sequence of positions of the spacecraft include optimal images captured by an imaging system of the spacecraft at a perilune point on the desired trajectory.

20. A non-transitory computer-readable storage medium embodied thereon a program executable by a processor for performing a spacecraft control method, spacecraft control method comprising:
receiving data indicative of measurements of a sequence of positions of the spacecraft;
generating, based on the received data, a position measurement of the spacecraft and a covariance of the position measurement;
based on the position measurement and the covariance of the position measurement, estimating a mean and a covariance of a state of the spacecraft using a probabilistic filter, wherein the state of the spacecraft includes a position and a velocity of the spacecraft;
determining a mean targeted state of the spacecraft using an unscented transform (UT) on the mean and the covariance of the state of the spacecraft;
determining control commands that steer the spacecraft from the mean targeted state to a reference state of the spacecraft, wherein the reference state includes a crossing point where a desired trajectory of the spacecraft and xz-plane intersect; and
controlling one or more actuators of the spacecraft based on the control commands to track the desired trajectory.
